(19) United States
(12) Patent Application Publication
(10) Pub. No.: US 2005/0166188 A1
(43) Pub. Date: Jul. 28, 2005

(54) Portal design system and methodology

(76) Inventors: Mark S. Secrist, Fort Collins, CO (US); Alex Nehmer, Tuebiugeu (DE); Rico Gundermann, Sulza (DE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/765,378

(22) Filed: Jan. 27, 2004

(51) Int. Cl. G06F 9/45

(52) U.S. Cl. 717/136

(57) ABSTRACT

A system and method for managing a portal adaptation lifecycle is disclosed that may include determining a construction design for an adapted portal application, determining a model for separation or presentation logic and application logic of an existing Web application to be adapted into the portal application, determining a navigation construction for the adapted portal application, selecting a level of customization to apply to the adapted portal application, and selecting an isolation model for isolating business logic from the adapted portal application.

### BACKGROUND

Over the last several years, web portals have risen in popularity as a way of aggregating, organizing, and presenting content in a highly uniform, customizable, and personalized way. As the technologies that enable the creation and management of these web portals have evolved, it is not only information content that is being offered, but application functionality as well. With application functionality making its way to the web portal, developers face a new dilemma in adapting application functionality to the characteristics and behavior of a web portal.

A portal is a web site that generally provides content and application functionality in a way that is both useful and meaningful to an end user. It may also serve some purpose from the portal provider's perspective, whether it is a public portal trying to attract web traffic to the site or an enterprise desiring to provide a central location for employees to obtain company information.

Most portals and portal frameworks contain the concept of a “portlet.” A portlet is a window to a specific set of content within the overall context of the portal page. Many portlets support the ability to customize the information displayed within this window. From the perspective of the portal framework or platform, portlets tend to look and behave much the same as individual windows running in a MICROSOFT WINDOWS™-based operating system. Portlets may be minimized, maximized, and re-arranged around the display screen to suit the taste of the individual portal user. From the developer's perspective, a portlet is simply a piece of code that plugs into a generalized framework. Different portal frameworks implement the concept of a portlet differently. In some cases, the portlet is a collection of SUN MICROSYSTEM'S JAVA™ SERVER PAGES™ (JSP) pages. In other cases, it may be a special type of class that implements certain interfaces. Regardless of how it is implemented, the portlet is generally responsible for presenting a specific set of content that may be tailored to a user's preferences. The portal framework is responsible for handling the infrastructure services, such as providing the overall presentation, user management, security, and personalization.

In the design and implementation of portals, it is generally useful to understand that typical web applications do not necessarily map easily over to a portal paradigm, especially in applications with multi-page interaction. Therefore, when converting a typical multi-page web site into a portal, developers generally re-code the entire web site from scratch into the portal paradigm. This process takes up considerable development time and expense.

### SUMMARY

Representative embodiments of the present invention are directed to a method for managing a portal adaptation lifecycle that may include determining a construction design for an adapted portal application, determining a model for separation or presentation logic and application logic of an existing Web application to be adapted into the portal application, determining a navigation construction for the adapted portal application, selecting a level of customization to apply to the adapted portal application, and selecting an isolation model for isolating business logic from the adapted portal application.

Further representative embodiments of the present invention are directed to a method for adapting a Web application to a portal application that may include adding at least one component of the Web application to a portal platform, creating a plurality of portlets within the portal platform, wherein each of the plurality includes pages representing a view for the at least one component of the Web application, defining at least one Web flow relationship representing interactions between the at least one component of the Web application, and converting the at least one Web flow relationship into at least one event, defined within the plurality of portlets, wherein the at least one event corresponds to the interactions.

Further representative embodiments of the present invention are directed to a methodology for converting a Web application into a portal application comprising moving Web components from the Web application into a portal framework corresponding to the portal application, dividing the portal application into a plurality of portlets, wherein each of the plurality serves content of one or more of the Web applications, and providing navigation resources to the portal application.

Further representative embodiments of the present invention are directed to a system for adapting a Web application to a portal application comprising means for adding one or more Web application components to the portal application, means for generating a plurality of portlets within the portal application, wherein each of the plurality includes a view for the one or more Web application components, means for defining at least one Web flow relationship representing interactions between the one or more Web application components, and means for converting the at least one Web flow relationship into at least one interaction event, defined within the plurality of portlets, wherein the at least one interaction event corresponds to the interactions.

### BRIEF DESCRIPTION OF THE DRAWINGS

For a more complete understanding of the present invention, reference is now made to the following descriptions taken in conjunction with the accompanying drawing, in which:

FIG. 1 is a flow chart representing a design consideration lifecycle according to the teachings herein;

FIG. 2 is block diagram illustrating a portal navigation relationship in one embodiment of the portalization methodology disclosed herein;

FIG. 3 is a flowchart illustrating a methodology used in adapting a Web application to a portal using one embodiment of the portal creation system described herein;

FIG. 4 is a flowchart illustrating a methodology used in adapting a Web application to a portal using steps in addition to those reflected in FIG. 3;

FIG. 5 is a flowchart illustrating a methodology for converting a Web application into a portal application according to an embodiment of portalization methodology disclosed herein;

FIG. 6 is a flowchart illustrating additional steps that may be added to the methodology, illustrated in FIG. 5, for converting a Web application into a portal application; and

FIG. 7 is a flowchart of one embodiment of a method for managing a portal adaptation lifecycle.

### DETAILED DESCRIPTION

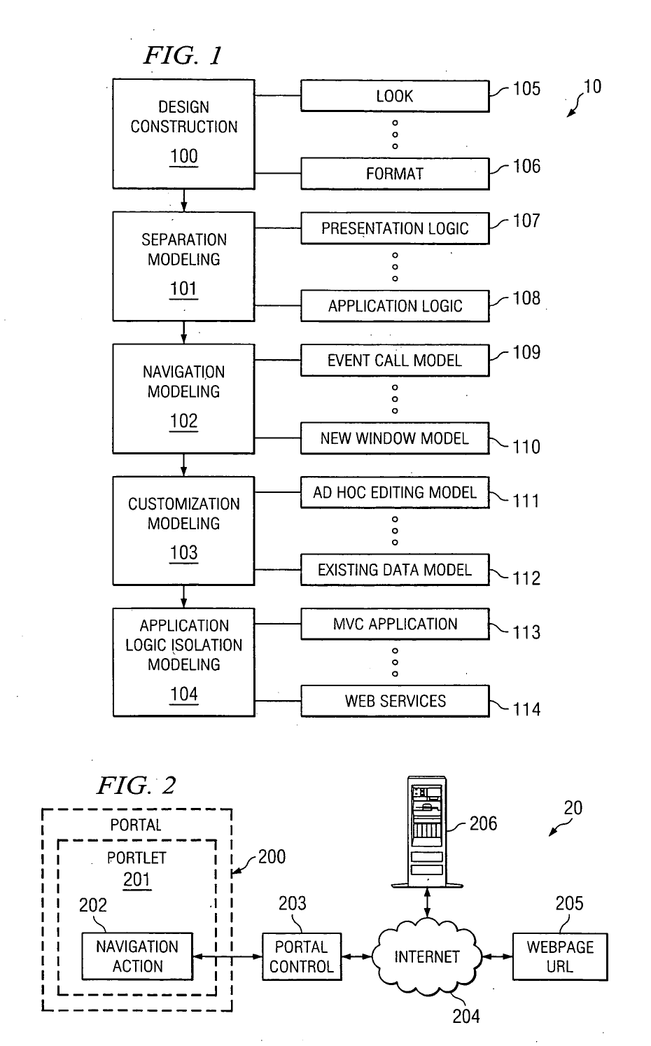

FIG. 1 is a flow chart representing design consideration lifecycle 10 according to the teachings herein. In designing Web applications that may either be implemented directly into a portal or converted from a standard hypertext markup language (HTML)-format into a portal format, the developer begins by considering, in step 100, any design constraints for the presentation and content of the site. Design constraints may include such issues as the visual theme or look 105 or the Web site or format 106 to be used in the presentation. In step 101, a model is generally created using elements such as flow charts, pseudo code, layout pages, and the like for developing the Web site having its presentation logic 107 separated from its application logic 108. In the HTML-format sites, developers typically hard-code formatting code along side application logic.

In step 102, the developer determines the appropriate site navigation model to employ by examining the model to find the experience that the developer has designed for the user. Navigation differs in portals because a call to a uniform resource locator (URL) from a portlet would cause the entire page to refresh, losing the portal in favor of the Web site called by the URL. The developer may consider implementing simple navigation through new window model 110, in which a URL call from the portlet would cause a new window to open for the called Web site. Additionally and alternatively, event call model 109 may be implemented, in which navigation occurs as an event call instead of a URL call. The URL calls or any Web component interactions may be converted into events for the portal application through appropriate code drafted by the developer. As the called site arrives at the portal, the code underlying the Web flow of the portal reformats the called Web page to be presented within the portlet from where the URL or event call originated.

Because portals generally allow users to customize or personalize content or layout of the Web site, the developer considers, in step 103, the desirable customization tools or models to include within the Web site. Customization tools and applications may be implemented by the developer by drafting the appropriate computer code that would use ad hoc editing model 111, in which a separate page, interactive window, JSP, or the like is run to gather and store information from the user accessing the Web site or portlet. For example, if a user desires to change content of a particular portlet, ad hoc editing model 111 would provide a separate page for the user to potentially select a different information source or add information to customize the portlet. A storage utility may be provided by the code drafted by the developer to preserve the customization information entered by the user Additionally and alternatively, existing data model 112 may be coded by the developer, which uses pre-existing information from the user's login to customize or personalize the Web site experience. For example, as a user logs in, the information that may be stored on the user is then accessible to the portal. If a user includes a game application in the portal that may require a new password or ID, the existing login information may be used to supply the new password and/or ID for the game application. In this process, the user is only required to log in once to the portal, while the portal logic takes care of logging into the game application for the user. In step 104, the developer may then select the different models for implementing the separation of application logic offered by the Web site, such as through model-view-control (MVC) applications 113 or Web services 114. Once these considerations have been addressed, the portal or convertible Web application may be constructed by the developer using the appropriate code instructions.

FIG. 2 is block diagram illustrating portal navigation relationship 20 in one embodiment of the portalization methodology disclosed herein. Portal 200 may contain various and multiple portlets. The code making up portlet 201 causes certain information or logic to be presented to a viewer that includes navigation action 202. In a typical Web paradigm, navigation action 202 may take the form of a hyperlink to a URL. However, in the portal paradigm, should a hyperlinked URL be selected within portlet 201, portal 200 would be replaced by a new browser window displaying the Web site related to that URL, thus, losing portal 200. Therefore, the portal paradigm uses different methods for overcoming this limitation.

The embodiment illustrated in FIG. 2 includes portal control 203. The code created by the developer underlying portal control 203 intercepts any hyperlinked URL calls made from portlet 201 or other locations within portal 200. Portal control 203 reconfigures or may even proxy the URL request of navigation action 202 from portlet 201. Based on that request, portal control 203 accesses Web page 205 or remote server 206 through Internet 204 to retrieve or receive information related to the request page or information. On receipt of Web page 205 or the information from remote server 206, portal control 203 configures and directs the information to be displayed within the construct of portlet 201. Portal control 203 would intercept all of the results from navigation requests made from portal 200 and direct the different results to the appropriate portlet for display.

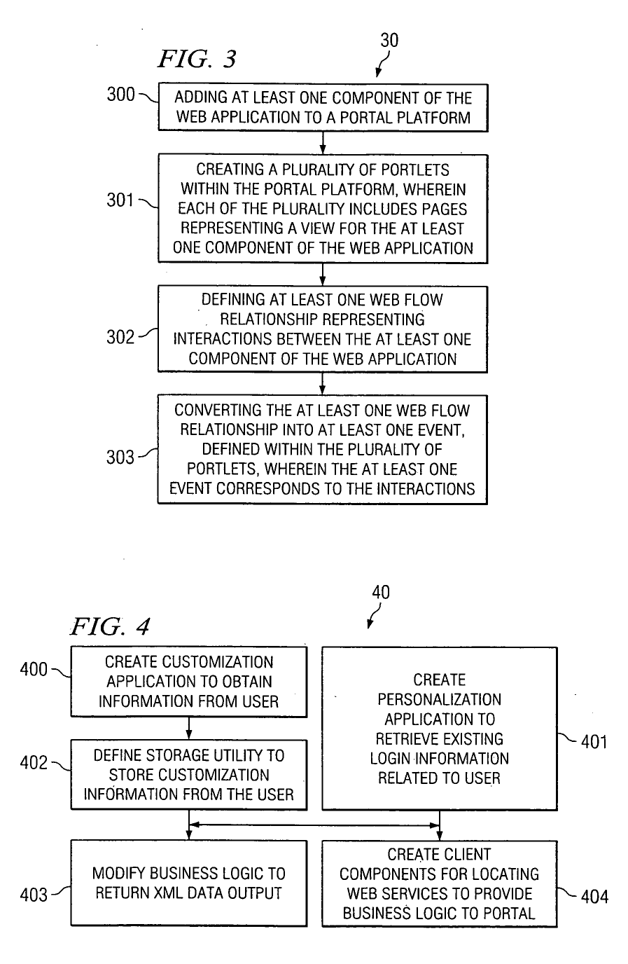

FIG. 3 is a flowchart illustrating methodology 30 used in adapting a Web application to a portal using one embodiment of the portal creation system described herein. Step 300 comprises adding at least one component of the Web application to a portal platform. Step 301 comprises creating a plurality of portlets within the portal platform, wherein each of the plurality includes pages representing a view for the at least one component of the Web application. Step 302 comprises defining at least one Web flow relationship representing interactions between the at least one component of the Web application. Step 303 comprises converting the at least one Web flow relationship into at least one event, defined within the plurality of portlets, wherein the at least one event corresponds to the interactions.

For example, an existing HTML page may include several different components that provide data to present to a user over the Web browser. These components may provide various information, such as news, access to email, stock prices, and the like, that is gathered from a database, Web service, or the like. A developer would generally move the components over to a portal platform. For each of the components moved, the developer would write code for a portlet. The portlets provide the display space for the information. As described above with respect to FIG. 2, the developer would then select and write code to handle the Web flow for interactions within the portlets and then convert the particular Web flow element to at least one event that corresponds to the interactions that may occur within the portlet, such as clicking to check email, clicking to read a news story, and the like.

In other embodiments, the methodology of FIG. 3 may include further steps, as illustrated in FIG. 4. Depending on the application or content being offered by the portal, the developer may select the level of customization or personalization to allow in the portal and implement the selected customization through appropriate computer code. In step 400, a customization application is coded by the developer to interact with the user to obtain customization information. This information may then be stored in step 402 by defining a storage utility in the appropriate underlying computer code for storing the information obtained from the user in the portal framework. This information may then be used by the portal code logic in assembling the presentation layers of the portal information. Additionally or alternatively, a personalization application may be coded by the developer in step 401 that retrieves existing login information related to a user. Once retrieved, this personalization information may also be incorporated into the presentation logic to make the user interface personalized to the user.

Additionally or alternatively, a developer may select a certain level or procedure to separate the business logic end from the presentation logic end and implement the selected separation in the code structure of the portal. In one embodiment illustrated by step 403, the business logic is modified to return its output as extensible markup language (XML) documents. Modern portal frameworks include utilities to read and present XML documents using template files such as extensible stylesheet language transformation (XSLT) documents. Thus, by returning XML documents, the output of the business logic becomes a standard format recognizable by most portal frameworks.

Additionally or alternatively to the modification of the existing business logic, client components may be created using appropriate code designed by the developer in step 404 for locating Web services to provide the business logic to the portal. Again, Web service or client interfaces may be provided in Simple Object Access Protocol (SOAP), which is an XML-based protocol, but leverages a standardized means for integrating Web services into the portal system. Web services may reside anywhere or be provided by different sources. Therefore, the portal system receives a good deal of application logic separation by using Web services to provide the business logic end.

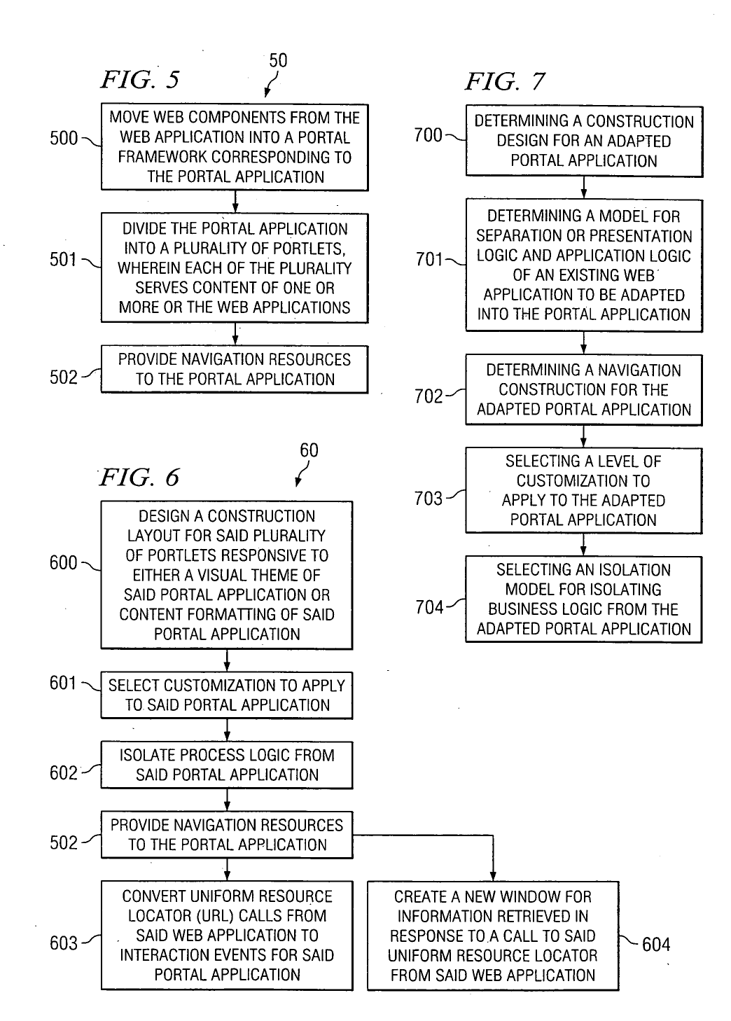

Methodology 50 for converting a Web application into a portal application is illustrated in FIG. 5. A Web application is typically constructed from a number of Web components appropriately coded by the developer that provide some information or application logic to the user. In step 500, the code underlying the Web components are moved by the developer from the Web application into a portal framework corresponding to the portal application. The portal application is then divided by the developer added code into a plurality of portlets in step 501, wherein each of the plurality serves content of one or more or the Web applications. Dividing the portal application into a plurality of portlets allows the componentization of the Web application to be realized in the portal framework. Because the navigation scheme of a Web application works from a different underlying paradigm, navigation resources are then provided to the portal application in step 502 by the developer adding the appropriate navigation code to the portal application.

In other embodiments, methodology 50 of FIG. 5 may include further steps 60, as illustrated in FIG. 6. In step 600, a construction layout is designed for the plurality of portlets responsive to either a visual theme of the portal application or content formatting of the portal application. The developer and any graphics artist may then code the construction layout to implement the desired usual theme. In step 601, a certain level of customization is selected to apply to the portal application. The customization code written by the developer allows users to change the presentation of the portal to his or her own desire. Process logic is then isolated from the portal application in step 602. This may be accomplished by, for example, including underlying code designed for modifying the process logic to output at least one data-descriptive metal language or by implementing process logic through use of one or more Web services. The navigation resources provided in step 502 may be implemented, in step 603, by drafting computer code to convert uniform resource locator (URL) calls from the Web application to interaction events for the portal application, or by including computer code to create a new window, in step 604, for information retrieved in response to a call to the URL from the Web application.

FIG. 7 is a flowchart of one embodiment of a method for managing a portal adaptation lifecycle. Step 700 comprises determining a construction design for an adapted portal application. Step 701 comprises determining a model for separation or presentation logic and application logic of an existing Web application to be adapted into the portal application. Step 702 comprises determining a navigation construction for the adapted portal application. Step 703 comprises selecting a level of customization to apply to the adapted portal application. Step 704 comprises selecting an isolation model for isolating business logic from the adapted portal application.

1. A method for managing a portal adaptation lifecycle comprising:
determining a construction design for an adapted portal application;
determining a model for separation or presentation logic and application logic of an existing Web application to be adapted into said portal application;
determining a navigation construction for said adapted portal application;
selecting a level of customization to apply to said adapted portal application; and
selecting an isolation model for isolating business logic from said adapted portal application.

2. The method of claim 1 wherein said determining a construction design includes one or more of:
determining a visual theme of said adapted portal application; and
determining a format of content for said adapted portal application.

3. The method of claim 1 wherein said determining a navigation construction includes one or more of:
retrieving selected information based on an event defined by uniform resource locator (URL) interaction in said Web application; and
creating a new window for information retrieved in response to a call to said URL from said Web application.

4. The method of claim 1 wherein said selecting a level of customization comprises one or more of:
presenting an interactive window to obtain customization information from a user, wherein said obtained customization information is stored in a portal framework; and
retrieving existing login information related to said user for inclusion in content of said adapted portal application.

5. The method of claim 1 wherein said selecting an isolation model comprises one or more of:
modifying said business model to return output as at least one data-descriptive metal language document; and
creating a component to connect said adapted portal application to one or more Web services for providing said business logic to said adapted portal application.

6. A method for adapting a Web application to a portal application comprising:
adding at least one component of said Web application to a portal platform;
creating a plurality of portlets within said portal platform, wherein each of said plurality includes pages representing a view for said at least one component of said Web application;
defining at least one Web flow relationship representing interactions between said at least one component of said Web application; and
converting said at least one Web flow relationship into at least one event, defined within said plurality of portlets, wherein said at least one event corresponds to said interactions.

7. The method of claim 6 further comprising:
creating a customization application for obtaining customization information from a user.

8. The method of claim 7 further comprising:
defining a storage utility to store said customization information to said portal platform.

9. The method of claim 6 further comprising:
modifying business logic to return output as a data-descriptive meta language document.

10. The method of claim 6 further comprising:
creating a client interface to search a plurality of Web services;
coding said client interface to select one or more of said plurality of Web services to provide business logic to said portal application.

11. A methodology for converting a Web application into a portal application comprising:
moving Web components from said Web application into a portal framework corresponding to said portal application;
dividing said portal application into a plurality of portlets, wherein each of said plurality serves content of one or more or said Web applications; and
providing navigation resources to said portal application.

12. The methodology of claim 11 further comprising:
designing a construction layout for said plurality of portlets responsive to one or more of:
a visual theme of said portal application; and
content formatting of said portal application.

13. The methodology of claim 11 further comprising:
selecting customization to apply to said portal application.

14. The methodology of claim 13 wherein said selecting customization comprises one or more of:
presenting a user interface to a user to gather customization information; and
obtaining personal login information from said portal framework related to said user.

15. The methodology of claim 14 wherein said customization information is stored within said portal framework for customization.

16. The methodology of claim 14 further comprising:
displaying a second user interface to a user for updating said personal login information.

17. The methodology of claim 11 further comprising:
isolating process logic from said portal application.

18. The methodology of claim 17 wherein said isolating comprises one or more of:
modifying said process logic to output at least one data-descriptive meta language document; and
receiving process output from one or more Web services.

19. The methodology of claim 11 wherein said providing step comprises one or more of:
converting uniform resource locator (URL) calls from said Web application to interaction events for said portal application; and
creating a new window for information retrieved in response to a call to said URL from said Web application.

20. The methodology of claim 19 further comprising:
retrieving information related to said URL on detection of said interaction events.

21. A system for adapting a Web application to a portal application comprising:
means for adding one or more Web application components to said portal application;
means for generating a plurality of portlets within said portal application, wherein each of said plurality includes a view for said one or more Web application components;
means for defining at least one Web flow relationship representing interactions between said one or more Web application components; and
means for converting said at least one Web flow relationship into at least one interaction event, defined within said plurality of portlets, wherein said at least one interaction event corresponds to said interactions.

22. The system of claim 21 further comprising:
means for creating a customization interface for obtaining customization information from a user.

23. The system of claim 22 further comprising:
means for generating a storage utility to store said customization information in said portal application.

24. The system of claim 21 further comprising:
means for modifying business logic of said one or more Web application components to return output as a data-descriptive meta language document.

25. The system of claim 21 further comprising:
means for creating a service interface to search a plurality of Web services; and
means for coding said service interface to select one or more of said plurality of Web services to provide business logic to said portal application.
